(19) United States
(12) Patent Application Publication
(10) Pub. No.: US 2006/0052997 A1
(43) Pub. Date: Mar. 9, 2006

(54) Automating identification of critical memory regions for pre-silicon operating systems

(75) Inventors: Adam Patrick Burns, Austin, TX (US); Joseph Anthony Perrie III, Austin, TX (US); Steven Leonard Roberts, Cedar Park, TX (US)

Correspondence Address: IBM CORPORATION (CS);C/O CARR LLP, 670 FOUNDERS SQUARE, 900 JACKSON STREET, DALLAS, TX, 75202, US

(73) Assignee: International Business Machines Corporation, Armonk, NY (US)

(21) Appl. No.: 10/937,694

(22) Filed: Sep. 9, 2004

(51) Int. Cl. G06F 9/45

(52) U.S. Cl. 703/22

(57) ABSTRACT

The present invention provides for automating identification of critical regions in memory. A behavioural software reference model of an operating system is certified as substantially error free. The behavioural software reference model is run of operating system. At least one access pattern of the behavioural software reference model is monitored. A cycle accurate software reference model of operating system is run. At least one access pattern of the cycle accurate software reference model is monitored. The at least one access pattern of the behavioural software reference model is compared with the at least one access pattern of the cycle accurate software reference model, thereby allowing a time saving in the testing process.

### TECHNICAL FIELD

The present invention relates generally to automating identification of critical memory regions and, more particularly, to automating identification of critical memory regions in a software model of a silicon integrated circuit.

### BACKGROUND

There are two different types of microprocessor models that are used during development. Cycle-accurate models are built from the hardware definition language which describes the chip functional logic. These models are produced so that most functionality of the chip is guaranteed before the logic is sent to be fabricated. Behavioral reference models are built so that software developers can run their code on an instruction set simulator that is operationally equivalent to the hardware. Behavioral reference models are comparatively much faster at simulating a microprocessor instruction set than cycle-accurate models.

Booting an operating system on a new chip is a test of the input-output functionality. It verifies that data are correctly written to and read from a memory subsystem. This disclosure describes the statistical algorithm by which we preprocess the behavioral models write access pattern and the idea of using a behavioral model in conjunction with a cycle-accurate model to ascertain both the quality of the microprocessor that is under test and the accuracy by which the behavioral model faithfully replicates the functionality of the physical chip.

This means that more than one silicon chip prototype is typically fabricated because errors are found in the first post-silicon construction, and booting operating system (OS) for a chip is itself a major achievement. However, even if the OS boots, there is no guarantee or indication that it has booted properly in the hardware chip system. Therefore, a lot of the booting of the system is done in software pre-silicon testing stage during the boot-up process. In the pre-silicon stage, a representation of the operating system is loaded into the circuit simulation, and the boot up is simulated.

Good industry simulation rates of cycle accurate models are about 50,000 chip cycles per second. To give some perspective, a simple “Hello World” program can take hundreds of thousands of cycles, whereas an OS boot will require hundreds of millions of cycles. In order to do an exact modeling of operating system behavior (that is, before the system is set up/fabricated in silicon), this can take days, or perhaps weeks, of simulation.

To help with time constraints, special devices, called hardware accelerators, are used which achieve processing speeds on the order of 50,000 cycles per second. Generally, Hardware accelerators are purpose-built machines used to run cycle-accurate models in simulation with decreased checking granularity. Instead of checking the status of the microprocessor under test every cycle as is done in chip simulation, hardware accelerators only allow periodic checking. The general rule as pertaining to hardware accelerators is that the longer one runs between stopping the simulation to check, the faster one can simulate a device. That being said, hardware accelerated simulation of cycle-accurate models is still an order-of-magnitude slower than a behavioral software reference model. Pre-computation of the boot can be done in about an hour on the behavioral software model. Checking those pre-computations on the cycle-accurate model would take about 168 hours on a state-of-the-art hardware accelerator. Hardware acceleration has typically been used to verify certain chip initialization sequences and other instruction sequences that are necessary for successful chip bring-up. However, use of the hardware accelerator has its own limitations. Hardware accelerated simulation of cycle-accurate models is still an order of magnitude slower than a behavioral software reference model.

Therefore, there is a need to enable the debugging of an operating system when the operating system is being behavioral software reference model.

### SUMMARY OF THE INVENTION

The present invention provides for automating identification of critical regions in memory. A behavioural software reference model of an operating system is certified as substantially error free. The behavioural software reference model is run of operating system. At least one access pattern of the behavioural software reference model is monitored. A cycle-accurate software reference model of operating system is run. At least one access pattern of the cycle accurate software reference model is monitored. The at least one access pattern of the behavioural software reference model is compared with the at least one access pattern of the cycle accurate software reference model.

### BRIEF DESCRIPTION OF THE DRAWINGS

For a more complete understanding of the present invention, and the advantages thereof, reference is now made to the following Detailed Description taken in conjunction with the accompanying drawings, in which:

FIG. 1 schematically illustrates a boot-up checking system for a pre-silicon stage; and

FIGS. 2A and 2B schematically illustrates a method for verifying the boot-up process in a pre-silicon stage.

### DETAILED DESCRIPTION

In the following discussion, numerous specific details are set forth to provide a thorough understanding of the present invention. However, those skilled in the art will appreciate that the present invention may be practiced without such specific details. In other instances, well-known elements have been illustrated in schematic or block diagram form in order not to obscure the present invention in unnecessary detail. Additionally, for the most part, details concerning network communications, electro-magnetic signaling techniques, and the like, have been omitted inasmuch as such details are not considered necessary to obtain a complete understanding of the present invention, and are considered to be within the understanding of persons of ordinary skill in the relevant art.

In the remainder of this description, a processing unit (PU) may be a sole processor of computations in a device. In such a situation, the PU is typically referred to as an MPU (main processing unit). The processing unit may also be one of many processing units that share the computational load according to some methodology or algorithm developed for a given computational device. For the remainder of this description, all references to processors shall use the term MPU whether the MPU is the sole computational element in the device or whether the MPU is sharing the computational element with other MPUs, unless otherwise indicated.

It is further noted that, unless indicated otherwise, all functions described herein may be performed in either hardware or software, or some combination thereof. In a preferred embodiment, however, the functions are performed by a processor, such as a computer or an electronic data processor, in accordance with code, such as computer program code, software, and/or integrated circuits that are coded to perform such functions, unless indicated otherwise.

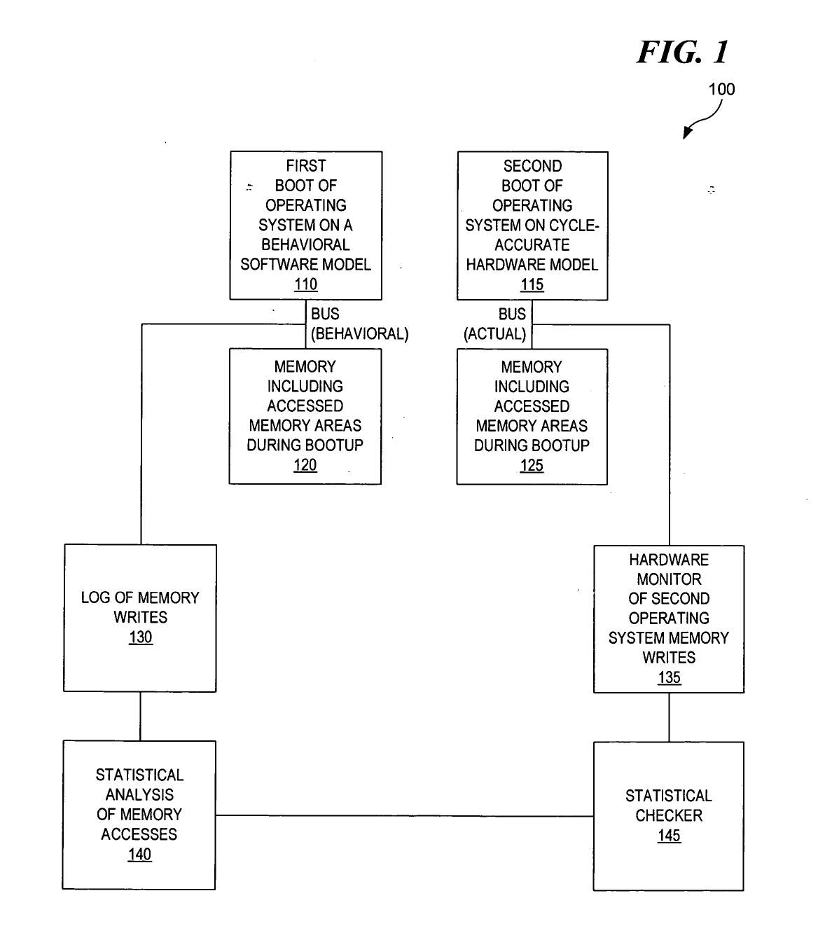

Turning now to FIG. 1, illustrated is a boot-up checking system 100. A first software emulation of an operating system is run on hardware 110. The first operating system is known to be working according to specification. The operating system, when running, accesses memory 120, such as RAM. The memory accessed areas 120 are then written into a memory write log 130. The log of memory writes 130 checks various characteristics of the checking of the memory areas. For instance, how often a particular area of memory is employed, when the checking occurs during boot-up, and so forth. A statistical analyzer 140 then runs various statistical algorithms to generate mathematical models of how the memory accesses occur.

A second operating system boot on a cycle-accurate model, independently derived, is run on a precise model of the hardware under test 115. The operating system, when running, accesses memory 125, such as RAM. The memory accessed areas 125 are monitored by a hardware monitor 135 of the second operating system memory writes. The hardware monitor 135 checks various characteristics of the checking of the memory areas. For instance, how often a particular area of memory is employed, when the checking occurs during boot-up, and so forth. A statistical analyzer 145 then runs various statistical algorithms to generate mathematical models of how the memory accesses occur.

Both of these models are checked by statistical checker 145. If the statistical analysis of behavior generated by the statistical analyzer 140 falls within tolerance of the statistical analysis of behavior generated by the hardware monitor 135, then the second software boot-up is statistically likely to not have errors in it. A behavioural software model is a software application that models the instruction set of a chip under test on a general purpose computer. In the system 100, there is a behavioural model and one cycle-accurate model. Generally, the operating system is booted on the behavioural model and the results generated from that.

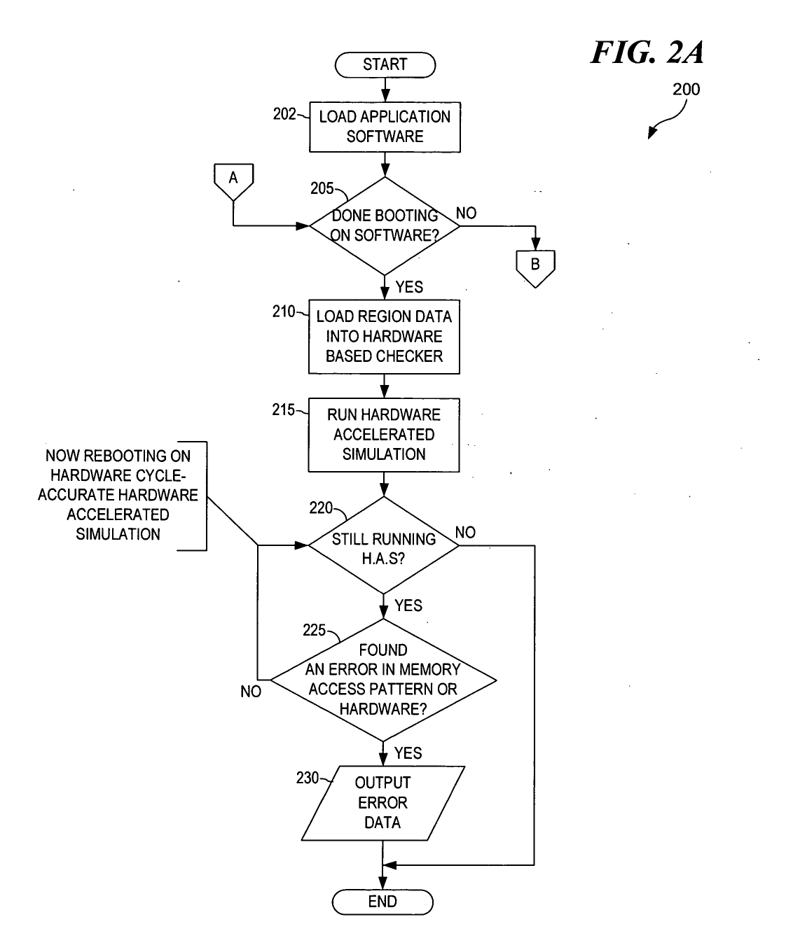

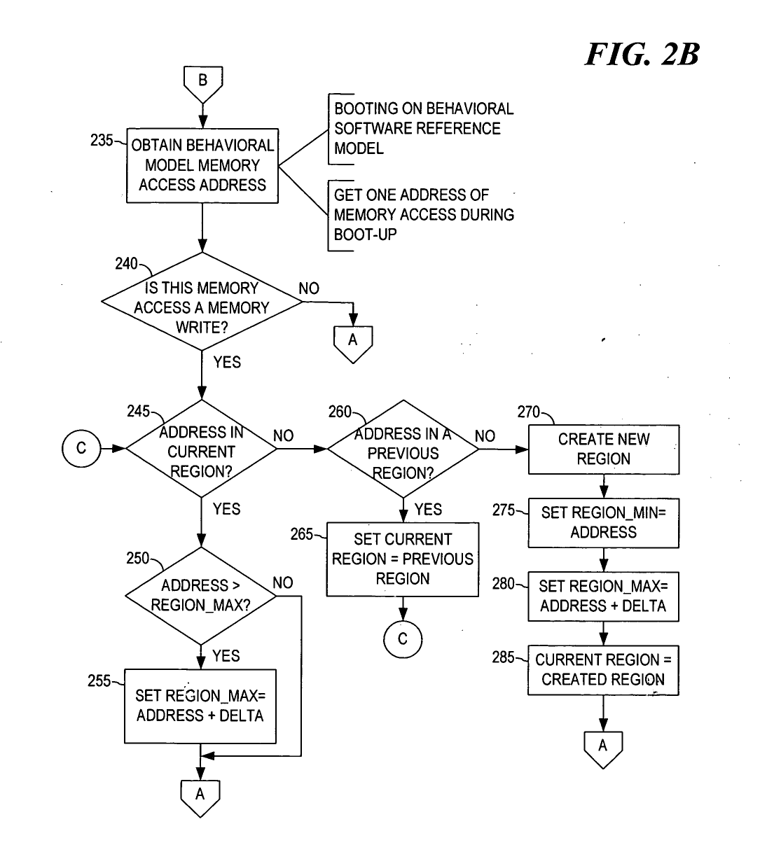

Turning now to FIG. 2A and FIG. 2B, illustrated is a method 200 for verifying the boot-up process in a pre-silicon stage. This test is used to determine whether the second version of the boot-up code is also substantially error free. Generally, the method 200 runs a software behavioral pre-computation, and then uses those results to ensure that what occurs on the boot sequence on the cycle-accurate model is statistically similar to what happened on the reference models. This method essentially is preprocessed on a normal computer with the results verified on an emulator, although this can be done on two separate machines.

In the flow 200, after start, application software to be computer-modeled and checked for memory access patters is loaded into memory in step 202 (FIG. 2A). It is then determined in step 205 whether the first boot 110 is finished. If the first boot 110 is finished, then in step 210, the region data is loaded into hardware based checker. In other words, the memory accesses 120 of the logged memory writes 130 are loaded into a statistical analyzer 140.

Then, in step 215, a hardware accelerated solution is run by the hardware boot 115, and memory regions are accessed in the memory 125. In other words, a more in-depth hardware booting is performed upon the boot software. In step 220, it is determined whether the hardware accelerated simulation is still running. If the hardware accelerated simulation is still running, then in step 225, it is determined whether an error was found in the patterns of memory access. Note that these patterns of memory accesses in hardware, the more thorough test, are tested in a manner analogous to the manner of memory in software of method 250. If an error is not found, then step 220 reexecutes. If an error is found, in step 230, error is outputted and ended. If the hardware cycle acceleration of step 220 has stopped running, the method 200 also ends.

However, if in step 205, the method 200 is not finished booting the software, then in step 235 (FIG. 2B), a memory read or memory write is obtained. In step 240, it is determined if the memory access is a memory write. If the memory access is not a memory write, then step 205 is reexecuted. However, if the memory access is a memory write, it is then determined in step 245 whether the memory write was performed in a predefined memory region. If the memory write was not in the predefined memory region, or this is the first time this step has executed since step 202, then in step 260 it is determined whether the memory address was in a region that was previously defined but not presently selected. If the memory address was in a region that was previously defined but not presently selected, or this is the first time this step has executed since step 202, a new memory region is defined in step 270.

In step 275, the new memory region is defined as the memory write that was detected in step 240. In step 280, the defined memory region maximum address area is set equal to region_min_address area plus delta, wherein delta is typically a predefined constant. The current region of memory access for determining the upper and lower boundaries of memory accesses is the areas defined by these memory accesses for checking for errors. If a subsequent memory access occurs at a lower memory area than defined as the min_address in step 275, the method 200 reverts back to the previous region and uses its defined min/max as the current min/max. The conditional “In Previous Region?” step 260 accounts for that step. However, if the address found is in a previous region, the method 200 responds by going back to a previously defined region. The “broadness” of the regions is variable and controlled by “delta” in the algorithm. The current region is set to be equal to the previous region in step 265, and step 245 again re-executes.

In any event, if the memory write was in the currently defined region, then in step 250, it is determined whether the memory accessed region is greater the region_max defined in step 280. If it is not, then step 205 again re-executes. However, if the memory access is out of range, then I step 255 the new upper bound of the memory region to be checked is set equal to the out of bound memory address plus a predefined delta of memory area.

Generally, the method steps illustrated in FIG. 2B is employable to defined a memory region in software, and at least some of the method steps of FIG. 2A are employable to check whether a hardware memory access falls within the predefined memory areas defined for the software memory access.

It is understood that the present invention can take many forms and embodiments. Accordingly, several variations may be made in the foregoing without departing from the spirit or the scope of the invention. The capabilities outlined herein allow for the possibility of a variety of programming models. This disclosure should not be read as preferring any particular programming model, but is instead directed to the underlying mechanisms on which these programming models can be built.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered desirable by those skilled in the art based upon a review of the foregoing description of preferred embodiments. Accordingly, it is appropriate that the appended claims be construed broadly and in a manner consistent with the scope of the invention.

1. A method for automating identification of critical regions in memory, comprising:
certifying a behavioural software reference model of an operating system as substantially error free;
running the behavioural software reference model of operating system;
monitoring at least one access pattern of the behavioural software reference model;
running a cycle accurate software reference model of operating system;
monitoring at least one access pattern of the cycle accurate software reference model; and
comparing the at least one access pattern of the behavioural software reference model with the at least one access pattern of the cycle accurate software reference model.

2. The method of claim 1, wherein monitoring at least one access pattern of the behavioural software reference model further comprises monitoring a plurality of access patterns.

3. The method of claim 1, wherein monitoring at least one access pattern of the cycle accurate software reference model further comprises monitoring a plurality of access patterns.

4. The method of claim 1, wherein the monitoring is performed with software.

5. The method of claim 1, further comprising determining that the behavioural software reference model is error free.

6. A computer program product for automating identification of critical regions in memory, the computer program product having a medium with a computer program embodied thereon, the computer program comprising:
computer code for certifying a behavioural software reference model of an operating system as substantially error free;
computer code for running the behavioural software reference model of operating system;
computer code for monitoring at least one access pattern of the behavioural software reference model;
computer code for running cycle accurate software reference model of operating system;
computer code for monitoring at least one access pattern of cycle accurate software reference model; and
computer code for comparing the at least one access pattern of the behavioural software reference model with the at least one access pattern of the cycle accurate behavioural software reference model.

7. The computer program product of claim 6, wherein computer code for monitoring at least one access pattern of the behavioural software reference model further comprises computer code for monitoring a plurality of access patterns.

8. The computer program product of claim 6, wherein computer code for monitoring at least one access pattern of the cycle accurate software reference model further comprises computer code for monitoring a plurality of access patterns.

9. The computer code of claim 6, further comprising computer code for determining that the behavioral behavioural software reference model is error free.

10. A processor for automating identification of critical regions in memory, the processor including a computer program comprising:
computer code for certifying a behavioural software reference model of an operating system as substantially error free;
computer code for running the behavioural software reference model of operating system;
computer code for monitoring at least one access pattern of the behavioural software reference model;
computer code for running cycle accurate software reference model of operating system;
computer code for monitoring at least one access pattern of cycle accurate software reference model; and
computer code for comparing the at least one access pattern of the behavioural software reference model with the at least one access pattern of the cycle accurate behavioural software reference model.

11. The computer program product of claim 10, wherein computer code for monitoring at least one access pattern of the behavioural software reference model further comprises computer code for monitoring a plurality of access patterns.

12. The computer program product of claim 10, wherein computer code for monitoring at least one access pattern of the cycle accurate software reference model further comprises computer code for monitoring a plurality of access patterns.

13. The computer code of claim 10, further comprising computer code for determining that the behavioural software reference model is error free.
